(19) United States
(12) Patent Application Publication
(10) Pub. No.: US 2022/0139187 A1
(43) Pub. Date: May 5, 2022

(54) SWIMGUARD PROTECTION SYSTEM

(71) Applicant: Swimguard, Inc., Dallas, TX (US)

(72) Inventors: Ryan WALTON-KING, Dallas, TX (US); Chris JOFFE, Santa Monica, CA (US); Jin Soo YANG, Anaheim, CA (US); Senthil KUMAR, Allen, TX (US)

(21) Appl. No.: 17/514,406

(22) Filed: Oct. 29, 2021

Related U.S. Application Data
(60) Provisional application No. 63/108,228, filed on Oct. 30, 2020.

(51) Int. Cl. G08B 21/04; G06K 9/00; G06N 3/02

(52) U.S. Cl. CPC G08B 21/043; G08B 21/0415; G06N 3/02; G06K 9/00315; G06K 9/00771

(57) ABSTRACT

A Swimguard protection system for detecting a person in distress in a body of water includes one or more sensors directed at the body of water, an alarm system configured to sound an audible alarm if a person is detected to be in distress, and a computing device in electrical communication with the one or more sensors and the alarm system. The computing device is configured to execute a deep learning algorithm that detects an event indicative that a person is in distress in the body of water. Characteristically, the computing device is further configured to send a trigger to the alarm system to provide an audio alarm upon the detection of such an event.

### CROSS-REFERENCE TO RELATED APPLICATIONS

This application claims the benefit of U.S. provisional application Ser. No. 63/108,228 filed Oct. 30, 2020, the disclosure of which is hereby incorporated in its entirety by reference herein.

### TECHNICAL FIELD

In at least one aspect, the present invention is direct to systems for detecting persons in distress in a body of water.

### BACKGROUND

Systems for preventing drowning in swimming pools and other bodies of water are clearly desirable. Prior art examples of such systems include U.S. Pat. Nos. 7,688,348; 5,638,048; and 5,049,859 and U.S. Pat. Pub. No. 20090303055. Although these systems work well, none of the prior art systems provide effective discrimination of a potential drowning event from other types of activity.

Accordingly, there is a need for improved systems that detect potential drowning events.

### SUMMARY

In at least one aspect, a Swimguard protection system for detecting a person in distress in a body of water is provided. The Swimguard protection system includes one or more sensors directed at the body of water, an alarm system configured to sound an audible alarm if a person is detected to be in distress, and a computing device in electrical communication with the one or more sensors and the alarm system. The computing device is configured to execute a deep learning algorithm that detects an event indicative that a person is in distress in the body of water. Characteristically, the computing device is further configured to send a trigger to the alarm system to provide an audio alarm upon the detection of such an event.

Advantageously, the Swimguard system is directed to the home market and to commercial applications (e.g., lakes/beaches/etc.)

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be had to the following detailed description, read in conjunction with the following drawings, wherein like reference numerals denote like elements and wherein:

FIG. 1. Schematic of the Swimguard system for detecting a person in distress in a body of water such as a swimming pool.

FIG. 2. Diagram of the architecture of an example of the Swimguard system.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

For any device described herein, linear dimensions and angles can be constructed with plus or minus 50 percent of the values indicated rounded to or truncated to two significant figures of the value provided in the examples. In a refinement, linear dimensions and angles can be constructed with plus or minus 30 percent of the values indicated rounded to or truncated to two significant figures of the value provided in the examples. In another refinement, linear dimensions and angles can be constructed with plus or minus 10 percent of the values indicated rounded to or truncated to two significant figures of the value provided in the examples.

The term “connected to” means that the electrical components referred to as connected to are in electrical communication. In a refinement, “connected to” means that the electrical components referred to as connected to are directly wired to each other. In another refinement, “connected to” means that the electrical components communicate wirelessly or by a combination of wired and wirelessly connected components. In another refinement, “connected to” means that one or more additional electrical components are interposed between the electrical components referred to as connected to with an electrical signal from an originating component being processed (e.g., filtered, amplified, modulated, rectified, attenuated, summed, subtracted, etc.) before being received to the component connected thereto.

The term “electrical communication” means that an electrical signal is either directly or indirectly sent from an originating electronic device to an electrical receiving device. Indirect electrical communication can involve the processing of the electrical signal, including but not limited to, filtering of the signal, amplification of the signal, rectification of the signal, modulation of the signal, attenuation of the signal, adding of the signal with another signal, subtracting the signal from another signal, subtracting another signal from the signal, and the like. Electrical communication can be accomplished with wired components, wirelessly connected components, or a combination thereof.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

The term “electrical signal” refers to the electrical output from an electronic device or the electrical input to an electronic device. The electrical signal is characterized by voltage and/or current. The electrical signal can be stationary with respect to time (e.g., a DC signal) or it can vary with respect to time.

The term “electronic component” refers is any physical entity in an electronic device or system used to affect electron states, electron flow, or the electric fields associated with the electrons. Examples of electronic components include, but are not limited to, capacitors, inductors, resistors, thyristors, diodes, transistors, etc. Electronic components can be passive or active.

The term “electronic device” or “system” refers to a physical entity formed from one or more electronic components to perform a predetermined function on an electrical signal.

It should be appreciated that in any figures for electronic devices, a series of electronic components connected by lines (e.g., wires) indicates that such electronic components are in electrical communication with each other. Moreover, when lines directed connect one electronic component to another, these electronic components can be connected to each other as defined above.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

Throughout this application, where publications are referenced, the disclosures of these publications in their entireties are hereby incorporated by reference into this application to more fully describe the state of the art to which this invention pertains.

Abbreviations:

“AWS” means Amazon Web Services.

“DL” means deep learning.

“IoT” means internet of things.

“ML” means machine learning.

In general, the present invention provides a system for determining whether or not a person is in distress in or proximate to a body of water, and in particular, swimming pools. Swimguard system is an electronic system that includes a plurality of electronic devices that applies a combination of technology algorithms, machine learning and notification mechanisms to detect a person who might be in distress in a swimming pool (or body of water) and then release a notification to a one or more devices which will cause alarm and awareness to the distress event.

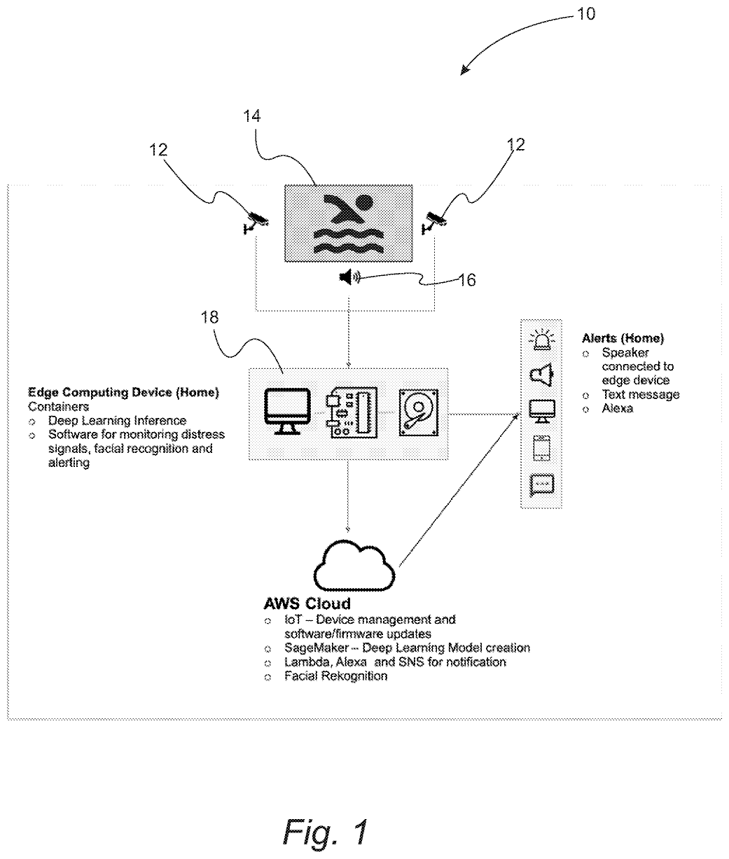

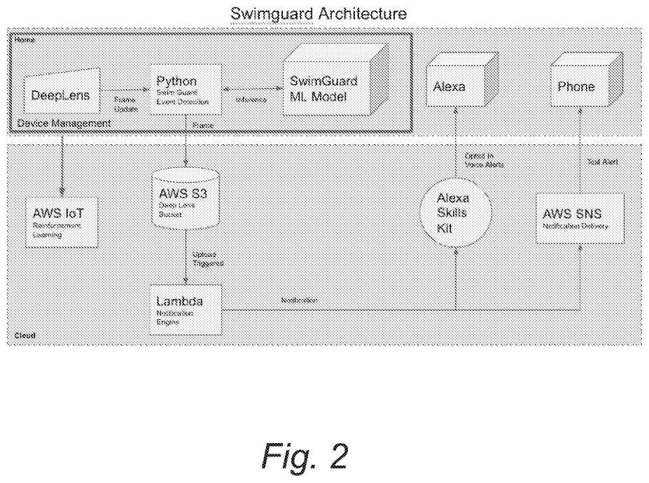

Referring to FIG. 1, a schematic of the Swimguard protection system for detecting a person in distress in a body of water is provided. FIG. 2 is a diagram of the architecture of an example of the Swimguard system. Swimguard system 10 includes one or more sensors 12 directed at the body of water 14. In a refinement, sensors 12 can be a video camera. In another refinement, the Swimguard system 10 includes at least 2 sensors. In a further refinement, the Swimguard system 10 includes at least 3 sensors. In another refinement, the Swimguard system 10 includes from 2 to 20 sensors. Swimguard system 10 also includes an alarm system 14 for sounding an audible alarm if a person is detected to be in distress. Edge computing device 16 is in electrical communication with sensors 12 and alarm system 14. Characteristically, computing device 16 executes a DL algorithm configured to detect an event indicative that a person is in distress in the body of water 14. If such an event is detected, a trigger signal is sent to alarm system 14, which can include a speaker that sounds an alarm. In addition, computing device 16 can send additional alerts such as text messages and commands to platforms such as Alexa. Characteristically, Swimguard system 10 implements a scenario analysis on the edge computing device 16 deployed at the body of water as opposed to bringing the analysis up to the cloud. Advantageously, this will enable us to trigger the alert faster than others.

Computing device 16 is configured to analyze an event and determine whether a person is in distress (using signs of drowning) as opposed to whether someone has merely intentionally entered body of water 12. Moreover, computing device 16 can be further configured to detect if a person has become still/unconscious. In performing this analysis, computing device 16 receives imaging signals, and in particular, video signals, from the one or more sensors 12. As part of this analysis, computing device 16 will perform digital signal processing. In a refinement, computing device 16 is configured to identify a human as an object detection and, in particular, to identify key body parts (e.g., a person's) face by eliminating the background such as water, pool toys, lane dividers. The computing device 16 can be further configured to identify a bounding perimeter (e.g., swimming pool area) that encloses body of water 14 or at least a portion of body of water 14 in which people are likely to be present. In a refinement, the bounding perimeter is a bounding polygon. Computing device 16 can be further configured to identify if a human is in the body of water or outside the body of water. In a particularly useful refinement, computing device 16 can be configured to detect is a child is entering the body of water.

In a variation, computing device 16 is further configured to execute one or more algorithms for performing facial recognition and/or sending alarm trigger signals to alarm system 14. The image process algorithms can include features such as water color sampling and detection of ripples/waves and lighting conditions to adjust to various conditions.

The DL algorithm set forth herein can apply such frameworks as MxNet or TensorFlow. OpenCV can be used to the computer vision algorithms of the Swimguard system. Heuristics 9 can be used for device management and software updates. Training and model validation can be done on a local PC and or on an online platform such as AWS SageMaker. A protection system can be constructed with Jetson Nano with attachments such as video cameras and speakers as alarms.

As set forth above, computing device 16 is configured to execute a deep learning algorithm that detects an event indicative that a person is in distress in the body of water. In a variation, the deep learning algorithm is a trained neural network, in in particular, a trained convolutional neural network. The neural network can be trained by having a test subject undertake an action that mimics drowning. Therefore, the video of these simulated events are recorded by sensor 12 and labeled as drown events. Other events (e.g., a person becoming unconscious) can also be simulated in this manner. Once the neural network is trained, it can be used in Swimguard system 10 to detect real drowning events.

In some aspects, the software applications set forth above can be packaged as Containers with the ability to update over the air (provided there is connectivity) using IoT. This aspect allows features to be added as they are developed.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A Swimguard protection system for detecting a person in distress in a body of water, the Swimguard protection system comprises:
one or more sensors directed at the body of water;
an alarm system configured to sound an audible alarm if a person is detected to be in distress; and
a computing device in electrical communication with the one or more sensors and the alarm system, the computing device configured to execute a deep learning algorithm that detects an event indicative that the person is in distress in the body of water, the computing device being further configured to send a trigger to the alarm system to provide an audio alarm upon the detection of such an event.

2. The Swimguard protection system of claim 1, wherein the computing device implements a scenario analysis at the body of water.

3. The Swimguard protection system of claim 1, wherein the one or more sensors include one or more video cameras.

4. The Swimguard protection system of claim 1 comprising at least 2 sensors.

5. The Swimguard protection system of claim 1 comprising 2 to 20 sensors.

6. The Swimguard protection system of claim 1, wherein the computing device is further configured to differentiate between the person in distress and the person intentionally entering the body of water.

7. The Swimguard protection system of claim 1, wherein the computing device is further configured to detect if the person has become still or unconscious.

8. The Swimguard protection system of claim 1, wherein the computing device is configured to receive video signals from the one or more sensors.

9. The Swimguard protection system of claim 1, wherein the computing device is configured to identify a human as an object detection and/or to identify key body parts.

10. The Swimguard protection system of claim 1, wherein the computing device is configured to identify a bounding perimeter that encloses the body of water or at least a portion of the body of water in which people are likely to be present.

11. The Swimguard protection system of claim 10, wherein the bounding perimeter is a bounding polygon.

12. The Swimguard protection system of claim 1, wherein the computing device is further configured to identify if a human is in the body of water or outside the body of water.

13. The Swimguard protection system of claim 1, wherein the computing device is further configured to detect a child entering the body of water.

14. The Swimguard protection system of claim 1, wherein the computing device is further configured to execute one or more algorithms for performing facial recognition and/or sending alarm trigger signals to the alarm system.

15. The Swimguard protection system of claim 1, wherein the deep learning algorithm is a trained neural network.

16. The Swimguard protection system of claim 1, wherein the deep learning algorithm is a trained convolutional neural network.
